(19) United States
(12) Patent Application Publication
(10) Pub. No.: US 2007/0111651 A1
(43) Pub. Date: May 17, 2007

(54) Air passage opening/closing system

(75) Inventors: Yasuhiro Sekito, Kariya-city (JP); Yoshihiko Okumura, Kariya-city (JP); Toshihiko Muraki, Kariya-city (JP)

Correspondence Address: HARNESS, DICKEY & PIERCE, P.L.C., P.O. BOX 828, BLOOMFIELD HILLS, MI, 48303, US

(73) Assignee: DENSO Corporation, Kariya-city (JP)

(21) Appl. No.: 11/586,108

(22) Filed: Oct. 25, 2006

(30) Foreign Application Priority Data
Oct. 27, 2005 (JP) 2005-312647

(51) Int. Cl. B60S 1/54

(52) U.S. Cl. 454/121

(57) ABSTRACT

An air passage opening/closing system preventing extraneous materials from depositing on a windup shaft drive mechanism of a film-shaped member, provided with a case forming air passages through which blown air flows, a film-shaped member arranged in the case and opening and closing openings of the air passages, a fixing part fixing one end of the film-shaped member at a peripheral edge of the openings, a windup shaft connected to the other end of the film-shaped member and winding up and feeding out the film-shaped member, and a windup shaft drive mechanisms rotating the windup shaft and making it move over the openings in a direction away from and approaching the fixing part, the windup shaft and windup shaft drive mechanisms being arranged at an air flow upstream side of the openings, a blown air blocking part covering at least an air flow upstream side part of the windup shaft drive mechanisms being provided.

### BACKGROUND OF THE INVENTION

1. Field of the Invention

The present invention relates to an air passage opening/closing system opening and closing an air passage by a film-shaped member (film door) and suitable for use in a vehicle air-conditioning system.

2. Description of the Related Art

In the past, an air passage opening/closing system using this type of film-shaped member to open and close an air passage was proposed in Japanese Patent Publication (A) No. 2005-199988.

In the prior art of this Japanese Patent Publication (A) No. 2005-199988, one end of the film-shaped member is fixed to the outside of the opening of the air passage, the other end of the film-shaped member is connected to a film-shaped member windup shaft, and this film-shaped member windup shaft rotates and moves in a direction away from and approaching one end of the film-shaped member (side where film-shaped member is fixed), whereby the film-shaped member is wound up or fed out.

Specifically, racks extending from one end to the other end of the film-shaped member are placed at the two ends of the film-shaped member windup shaft and pinions at the two ends of the film-shaped member windup shaft are meshed with the racks so as to enable the film-shaped member windup shaft to rotate and move.

When the film-shaped member is completely wound up, the opening is fully opened, while when the film-shaped member is completely fed out (unwound), the opening is fully closed.

In this prior art, the film-shaped member, film-shaped member windup shaft, racks, pinions, etc. are arranged at the air flow upstream side of the opening and the film-shaped member opens and closes the opening from the air flow upstream side.

Due to this, the film-shaped member is pushed by the pressure of the blown air against the seal surface at the periphery of the opening resulting in a sealing ability.

However, in this prior art, since the pinions and racks are arranged in the air passage at the air flow upstream side of the opening and the blown air directly strikes the pinions and rack, extraneous materials (sand, dust, etc.) which contaminate the blown air end up depositing on the pinions and racks and being caught between the pinions and racks.

If extraneous materials are caught between the pinions and racks, the problems arise that rotation of the pinions is obstructed, malfunctions occur, and noise is generated.

### SUMMARY OF THE INVENTION

An object of the present invention, in consideration of this point, is to prevent extraneous materials from depositing on a windup shaft drive mechanism comprised of racks, pinions, etc. and thereby suppress malfunctions and occurrence of noise and improve the reliability of operation and quietness.

To achieve this object, the present invention provides an air passage opening/closing system provided with a case (1a) forming an air passage (3a, 13, 15, 16, 17) through which blown air flows, a film-shaped member (23) arranged in said case (la) and opening and closing an opening (11a, 12a, 27) of said air passage (3a, 13, 15, 16, 17), a fixing part (24) fixing one end of the film-shaped member (23) at a peripheral edge of the opening (11a, 12a, 27), a windup shaft (25) connected to the other end of the film-shaped member (23) and winding up and feeding out the film-shaped member (23), and a windup shaft drive mechanism (26A and 26B) rotating said windup shaft (25) and making it move over the opening (11a, 12a, 27) in a direction (D) away from and approaching the fixing part (24), the windup shaft (25) and windup shaft drive mechanism (26A and 26B) being arranged at an air flow upstream side of the opening (11a, 12a, 27), a blown air blocking part (35) covering at least an air flow upstream side part of the windup shaft drive mechanism (26A and 26B) being provided.

According to this, the blown air blocking part (35) covering at least an air flow upstream side part of the windup shaft drive mechanism (26A and 26B) can prevent the blown air from directly striking the windup shaft drive mechanism (26A and 26B).

For this reason, extraneous materials which contaminate the blown air (sand, dust, etc.) can be kept from depositing at the windup shaft drive mechanism (26A and 26B).

As a result, the trouble can be avoided of extraneous materials being caught inside the windup shaft drive mechanism (26A and 26B), obstructing driving of the windup shaft, causing malfunctions, and generating noise.

Further, in the present invention, the windup shaft drive mechanism (26A and 26B) is provided at the end of the windup shaft (25), a partition wall (37) extending from the peripheral edge of the opening (11a, 12a, 27) to the blown air blocking part (35) is formed between the windup shaft drive mechanism (26A and 26B) and film-shaped member (23), and a relief hole (39) in which the windup shaft (25) is inserted is formed at the partition wall (37) in an elongated shape extending across a range of movement of the windup shaft (25).

According to this, since the windup shaft drive mechanism (26A and 26B) and the film-shaped member (23) have a partition wall (37) formed between them, blown air trying to sneak around the sides of the blown air blocking part (35) and flow to the windup shaft drive mechanism (26A and 26B) can be blocked by the partition wall (37).

For this reason, not only can the blown air be prevented from directly striking the windup shaft drive mechanism (26A and 26B), but also the blown air can be prevented from sneaking around the sides of the blown air blocking part (35) and flowing to the windup shaft drive mechanism (26A and 26B).

As a result, extraneous materials (sand, dust, etc.) which contaminate the blown air can be kept from depositing at the windup shaft drive mechanism (26A and 26B).

Further, since the partition wall (37) is formed with relief holes (39) in which the windup shaft (25) is inserted as an elongated shape extending across the range of movement of the windup shaft (25), the windup shaft (25) can be prevented from interfering with the partition wall (37).

Further, the present invention forms the partition wall (37) integrally with the blown air blocking part (35) by plastic, so it is possible to facilitate the assembly of the partition wall (37) and blown air blocking part (35).

Further, the present invention forms the windup shaft drive mechanism (26A and 26B) by a pinion (30) provided at an end of the windup shaft (25) and a rack (29) meshing with the pinion (30). The relief hole (39) is formed so that the outer circumference of the windup shaft (25) at the far side from the rack (29) slides with the end face (39b) of the relief hole (39).

According to this, since the outer circumference of the windup shaft (25) at the side far from the rack (29) slides with the end face (39b) of the relief hole (39), the windup shaft (25) is acted on by a force in a direction pushed from the end face (39b) of the relief hole (39) to the rack (29) side.

For this reason, the pinion (30) provided at the end of the windup shaft (25) is pushed against the rack (29), so the pinion (30) can be prevented from detaching from the rack (29) and spinning idlely.

As a result, slipping of the rotation of the windup shaft (25) can be prevented and the windup shaft (25) can be rotated and moved in a direction away from and approaching the fixing part (24).

Further, the present invention forms slits (41) extending substantially in parallel with the end face (39b) at a part of the partition wall (37) near the end face (39b).

According to this, when extraneous materials deposit at the sliding parts of the outer circumference of the windup shaft (25) and the end face (39b) of the relief hole (39), the end face (39b) of the relief hole (39) can be made to elastically deform by the slits (41).

That is, by deformation by crushing of the slits (41), the end face (39b) can elastically deform so as to release the caught extraneous materials.

For this reason, the problem can be prevented of extraneous materials being caught at the sliding parts of the outer circumference of the windup shaft (25) and the end face (39b) of the relief hole (39) and obstructing movement of the windup shaft.

Further, in the present invention, the windup shaft drive mechanism (26A and 26B) is formed by a pinion (30) provided at an end of the windup shaft (25) and a rack (29) meshing with the pinion (30), and the relief hole (39) is formed so that a gap (40) of a predetermined dimension is set between the outer circumference of the windup shaft (25) at the side close to the rack (29) and the end face (39a) of the relief hole (39).

According to this, the outer circumference of the windup shaft (25) at the side close to the rack (29) does not directly slide with the end face (39a) of the relief hole (39), so no extraneous materials will be caught between the outer circumference and the end face (39a) of the relief hole (39).

For this reason, the problem can be avoided of extraneous materials being caught and obstructing movement of the windup shaft.

Further, the present invention forms the rack (29) by a plastic and forms the gear roots (29a) of the rack (29) in cross-sectional V-shapes, so forms extraneous materials catches (29b) between the gear roots (29a) and the gear tips (30a) of the pinion (30).

In the present invention, a partition wall (37) is provided so as to prevent blown air from sneaking around the sides of the blown air blocking part (35) and flowing to the windup shaft drive mechanisms (26A and 26B), but the partition wall (37) is formed with a relief hole (39) in which the windup shaft (25) is inserted, so part of the blown air passes through the relief hole (39) and ends up flowing to the windup shaft drive mechanism (26A and 26B).

For this reason, in the present invention as well, while slight in amount, extraneous materials which contaminate the blown air sometimes deposit at the windup shaft drive mechanism (26A and 26B).

Considering this point, in the present invention, the rack (29) is formed out of plastic to form the gear roots (29a) of the rack (29) in cross-sectional V-shapes.

That is, when forming the rack (29) by cutting metal, since a blade is used to cut away the metal, there are limits to how narrowly and deeply the gear roots (29a) of the rack (29) can be made, so forming the gear roots (29a) into cross-sectional V-shapes is difficult. On the other hand, as shown in the present invention, if forming the rack (29) from plastic, there is no limitation in shaping and the gear roots (29a) can be easily formed into cross-sectional V-shapes.

Further, since the gear roots (29a) of the rack (29) are formed in cross-sectional V-shapes, extraneous materials catches (29b) can be formed between the gear roots (29a) of the rack (29) and the gear tips (30a) of the pinion (30).

For this reason, even if extraneous materials deposit at the rack (29), the extraneous materials are collected at the extraneous materials catches (31c), so the problem can be avoided of the extraneous materials being caught between the rack (29) and pinion (30) and obstructing movement of the windup shaft.

Further, the present invention integrally forms the rack (29) with the partition wall (37) and blown air blocking part (35), so it is possible to easily assemble not only the partition wall (37) and blown air blocking part (35), but also the rack (29).

Further, the present invention allows movement of the windup shaft (25) at the partition wall (37) and provides a blocking member (43 to 46) blocking the relief hole (39).

According to this, part of the blown air passing through the relief hole (39) and flowing to the windup shaft drive mechanism (26A and 26B) can be prevented.

For this reason, extraneous materials which contaminate the blown air (sand, dust, etc.) can be further kept from depositing at the windup shaft drive mechanism (26A and 26B).

Further, in the present invention, specifically, the blocking member is formed by a film-shaped blocking member (43) arranged so as to overlap the relief hole (39) at the partition wall (37), a length of the film-shaped blocking member (43) in the movement direction (D) being longer than the length of the relief hole (39) in the movement direction (D) by exactly a predetermined dimension, one side of the film-shaped blocking member (43) in the movement direction (D) being folded up and the other side being extended along with movement of the windup shaft (25).

Due to this, it is possible to allow movement of the windup shaft (25) and block the relief hole (39).

Further, in the present invention, specifically the blocking member is formed by a multilayer slide door (44) arranged so as to overlap the relief hole (39) at the partition wall (37), the multilayer slide door (44) being comprised of a plurality of thin plate members (44a to 44e) stacked in the axial direction of the windup shaft (25), thin plate members at one side of the plurality of thin plate member (44a to 44e) in the movement direction (D) being stacked so as to be overlaid and thin plate members at the other side being stacked so as to be offset in a staircase manner along with movement of the windup shaft (25).

Further, in the present invention, specifically, the blocking member may be formed by an elastic member (45) arranged so as to overlap the relief hole (39) at the partition wall (37), the elastic member (45) may be formed with split surfaces (45a) extending substantially parallel to the movement direction (D) of the windup shaft (25), and the windup shaft (25) may push against the split surfaces (45a) and elastically deform the elastic member (45) to move between the split surfaces (45a).

Further, in the present invention, specifically, the blocking member may be formed by a large number of elastically deformable fiber- or strip-like brush members (46) projecting from the inner circumference of the relief hole (39) to the inside.

According to this, the windup shaft (25) can push against and elastically deform the brush members (46) while moving inside the relief hole (39) and the brush members (46) can block the relief hole (39). Incidentally, the reference numerals in parentheses after the above means are examples showing the correspondence with the specific means described in the later explained embodiment.

### BRIEF DESCRIPTION OF THE DRAWINGS

The present invention may be more fully understood from the description of the preferred embodiments of the invention set forth below together with the accompanying drawings, in which

FIG. 1 is a schematic cross-sectional view showing an air-conditioning unit in a first embodiment of the present invention;

FIG. 2 is a cross-sectional view of the part A-A in FIG. 1;

FIG. 3 is a disassembled perspective view of a cassette type film door in FIG. 1;

FIG. 4 is an enlarged cross-sectional view of the part B-B in FIG. 2;

FIG. 5 is an enlarged view of a rack and pinion in a first embodiment and shows the state of the pinion meshed with the rack;

FIG. 6 is a perspective view of the vicinity of a relief hole of a first partition wall in the first embodiment;

FIG. 7A is a schematic cross-sectional view of principal parts of a cold air passage opening/closing unit of a film door in a second embodiment of the present invention and shows the state with the cold air side opening fully closed, while FIG. 7B is a schematic cross-sectional view showing the state of the cold air side opening in FIG. 7A fully opened;

FIG. 8A is a schematic cross-sectional view of principal parts of a cold air passage opening/closing unit of a film door in a third embodiment of the present invention and shows the state with the cold air side opening fully closed, while FIG. 8B is a schematic cross-sectional view showing the state of the cold air side opening in FIG. 8A fully opened;

FIG. 9A is a schematic front view of a relief hole of a first partition wall of the cold air passage opening/closing unit in a fourth embodiment of the present invention and shows the state of the cold air side opening fully closed, while FIG. 9B is a schematic cross-sectional view showing the state of the cold air side opening in FIG. 9A fully opened; and

FIG. 10A is a schematic front view of a relief hole of a first partition wall of the cold air passage opening/closing unit in a fifth embodiment of the present invention and shows the state of the cold air side opening fully closed, while FIG. 10B is a schematic cross-sectional view showing the state of the cold air side opening in FIG. 10A fully opened.

### DESCRIPTION OF THE PREFERRED EMBODIMENTS

### First Embodiment

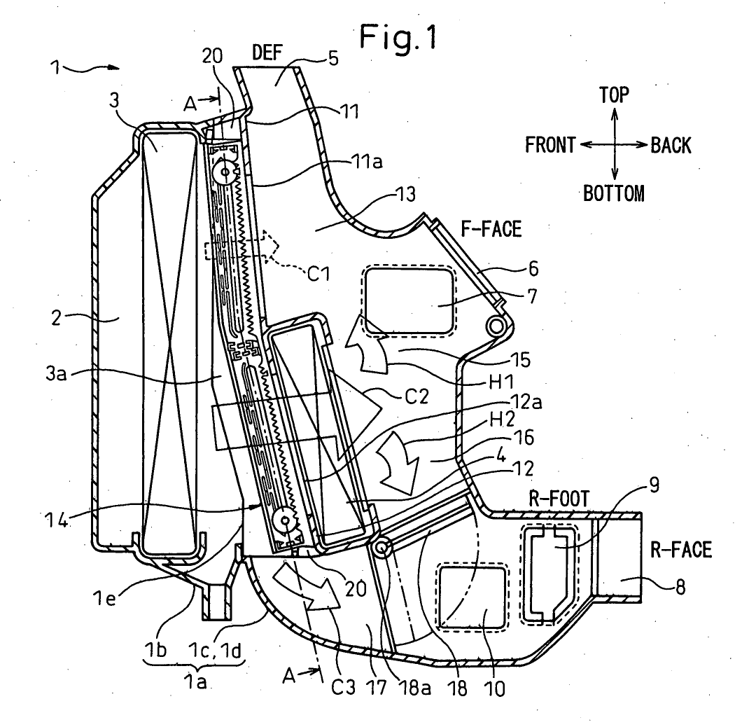

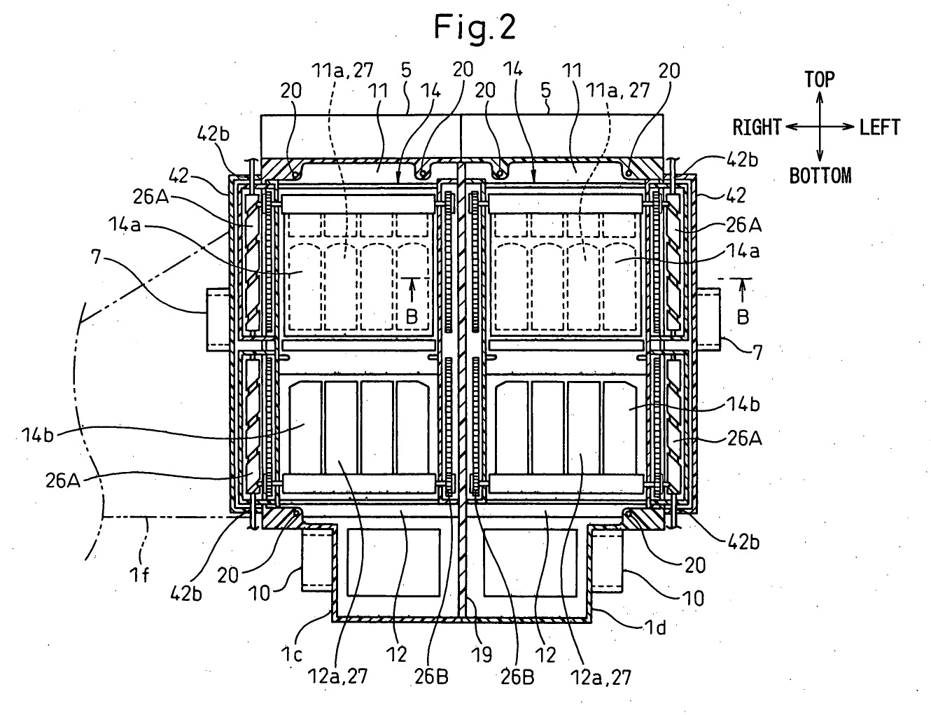

Below, a first embodiment of the present invention will be explained based on FIG. 1 to FIG. 6. FIG. 1 shows the overall configuration in the case of applying the present invention to a vehicle air-conditioning system, while FIG. 2 is a cross-sectional view of the part A-A in FIG. 1.

The air-conditioning unit 1 of the vehicle air-conditioning system in this embodiment has a plastic air-conditioner case 1a. This air-conditioner case 1a is positioned at the inside from the instrument panel in the passenger compartment of the vehicle at the approximate center location in the vehicle width (left-right) direction and is positioned as shown by the arrows of FIG. 1 and FIG. 2 with respect to the front-back, top-bottom, and left-right directions of the vehicle.

The air-conditioner case 1a, for convenience in removal from the mold in the case of molding and due to reasons such as assembly of the air-conditioner in the case, is specifically formed divided into a plurality of case members 1b, 1c, and 1d. These plurality of case members 1b, 1c, and 1d are then fastened together.

More specifically, the air-conditioner case 1a is divided at a split surface (mold split surface) 1e into a front side case member 1b and rear side case members 1c and 1d. Further, the rear side case members 1c and 1d are formed split at the substantial center of the vehicle left-right (width) direction into two left-right case members. That is, the joined surfaces of the rear side case members 1c and 1d is the vertical plane extending in the vehicle front-back direction.

Note that the vehicle left-right direction is the direction perpendicular to the paper surface of FIG. 1, while the vehicle front-back direction is the left-right direction of FIG. 1.

At the vehicle frontmost location in the air-conditioner case 1a, an air inlet space 2 is formed through which blown air of a not shown blowing unit flows through a connection duct 1f (see FIG. 2).

This connection duct 1f is arranged at the surface of the air-conditioner case 1a at the navigator's seat (surface of vehicle right side). An air outlet of a blowing unit (not shown) arranged inside from the instrument panel in the passenger compartment at the navigator's seat is connected to the connection duct 1f. Therefore, by operating an electric blower in the blowing unit, air flows from the connection duct 1f to the inside of the air inlet space 2.

Note that this embodiment is applied to a left hand steering wheel car, so the connection duct 1f is arranged at the surface of the air-conditioner case 1a at the vehicle right hand side, but when applied to a right hand steering wheel car, the connection duct 1f is arranged at the surface of the air-conditioner case 1a at the vehicle left hand side.

The air-conditioner case 1a is provided inside it with an evaporator 3 and heater core 4 in that order from the air upstream side. This evaporator 3 is a cooling use heat exchanger provided in a known refrigeration cycle and evaporating a refrigerant while absorbing heat from the air blown into the air-conditioner case 1a to thereby cool the blown air.

Note that in the refrigeration cycle, a compressor (not shown) sucking in and compressing a refrigerant is driven to rotate through a not shown pulley, belt, etc. by a not shown vehicle engine.

As this compressor, in this example, a fixed capacity compressor operating an electromagnetic clutch to change the operating rate of the compressor and adjust the discharge ability of the refrigerant is used, but a variable capacity compressor able to be adjusted in discharge ability of the refrigerant by a change of the discharge capacity may also be used.

Further, the heater core 4 is a heating use heat exchanger using the hot water of the vehicle engine (engine cooling water) as a heat source to heat the air in the air-conditioner case 1a. The heater core 4 is arranged so that the top part is inclined to the vehicle front side by a predetermined angle.

The air downstream end of the air-conditioner case 1a is formed with a plurality of vent openings 5 to 10. Among these, a defroster opening 5 is arranged at the top surface of the air-conditioner case 1a. This defroster opening 5 has a not shown defroster duct connected to it. The defroster vent of the front end of this defroster duct blows air-conditioned air into the passenger compartment toward the surface of the windshield.

A front seat face opening 6 is arranged at the surface of the air-conditioner case 1a at the vehicle rear side. This front seat face opening 6 has a not shown front seat face duct connected to it. The face vent of the front end of this face duct blows air-conditioned air toward the upper bodies of the front seat (driver's seat and navigator's seat) passengers.

Front seat foot openings 7 are arranged at both the left and right sides above the surface of the air-conditioner case 1a at the vehicle rear side. These front seat foot openings 7 have not shown front seat foot ducts connected to them and blow air-conditioned air toward the feet of the front seat (driver's seat and navigator's seat) passengers.

A rear seat face opening 8 is arranged at below the surface of the air-conditioner case 1a at the vehicle rear side. This rear seat face opening 8 has a not shown rear seat face duct connected to it. Air-conditioned air is blown through this rear seat face duct from a vent provided at the bottom center of the passenger compartment toward the upper bodies of the rear seat passengers.

Rear seat foot openings 9 are positioned at both the left and right sides below the surface of the air-conditioner case 1a at the vehicle rear side. These rear seat foot openings 9 have not shown rear seat foot ducts connected to them. Air-conditioned air is blown through the rear seat foot ducts toward the feet of the rear seat passengers.

Further, B-pillar openings 10 are positioned at both the left and right sides below the surface of the air-conditioner case 1a at the vehicle rear side. The B-pillar openings 10 have not shown B-pillar ducts connected to them. Air-conditioned air is blown through these B-pillar ducts from a vent provided between the not shown B-pillars (among the pillars forming the space inside the passenger compartment, the second pillar from the front seen from the side surface) toward the upper bodies of the rear seat passengers.

Note that in this embodiment, the openings 5 to 10 are designed to be opened and closed by not shown vent mode doors.

Above a heater core 4, a cold air side opening panel 11 is formed integrally with the rear side case members 1c and 1d. This cold air side opening panel 11 is formed inside it with a cold air side opening 11a. Further, at the front side of the heater core 4 (air flow upstream side), a hot air side opening panel 12 is formed integrally with the rear side case members 1c and 1d. This hot air side opening panel 12 is formed inside it with a hot air side opening 12a.

The hot air side opening panel 12 is formed parallel to the heater core 4 with its top end inclined to the vehicle front side. The cold air side opening panel 11 is formed with its top end inclined to the vehicle front side by a gentler angle than the hot air side opening panel 12. For this reason, the bottom end of the cold air side opening panel 11 and the top end of the hot air side opening panel 12 are joined with a slight angle.

At the air flow downstream side of the evaporator 3, a cold air passage 3a through which cold air cooled by passing through the evaporator 3 flows is formed across substantially the entire cross-section of the air-conditioner case 1a. The cold air flowing through the upper side of the cold air passage 3a, as shown by the arrow C1, passes through the cold air side opening 11a of the cold air side opening panel 11 and flows to a first bypass passage 13. On the other hand, the cold air flowing through the bottom side of the cold air passage 3a passes through the hot air side opening 12a of the hot air side opening panel 12 as shown by the arrow C2 and is heated by the heater core 4 to become hot air.

Further, a cassette type film door 14 opening and closing the two openings 11a, 12a is arranged abutting against the front surfaces of the cold air side opening panel 11 and hot air side opening panel 12 (surfaces of air flow upstream side). The film door 14 opens and closes the two openings 11a, 12a so as to adjust the flow rate of the cold air C1 flowing through the first bypass passage 13 and the flow rate of the cold air C2 heated by the heater core 4.

At the air flow downstream side region of the heater core 4, an upper side first hot air passage 15 and a lower side second hot air passage 16 are formed. The hot air heated by the heater core 4 is divided into hot air H1 passing through the first hot air passage 15 and heading toward the defroster opening 5, front seat face opening 6, and front seat foot openings 7 and hot air H2 passing through the second hot air passage 16 and heating toward the rear seat face opening 8, rear seat foot openings 9, and B-pillar openings 10.

The film door 14 adjusts the flow rate of the cold air C1 flowing through the first bypass passage 13 and the flow rate of the cold air C2 heated by the heater core 4, whereby the cold air C1 and the hot air H1 flowing through the first hot air passage 15 are mixed by a predetermined ratio and form the desired temperature air-conditioned air.

Note that FIG. 1 shows the state with the film door 14 fully closing the cold air side opening 11a of the cold air side opening panel 11 and blocking the cold air C1 and fully opening the hot air side opening 12a of the hot air side opening panel 12 and maximizing the flow rate of the cold air C2.

Further, below the heater core 4, as shown by the arrow C3, a second bypass passage 17 is formed. Cold air flowing through the bottommost past of the cold air passage 3a flows to the second bypass passage 17.

This second bypass passage 17 has a rear seat air mix door 18 arranged at it. The second bypass passage 17 is designed to be opened and closed by the rear seat air mix door 18. This rear seat air mix door 18 is a plate-shaped door able to pivot about a rotary shaft 18a.

This rear seat air mix door 18 enables the hot air H2 and the cold air C3 to be mixed by a predetermined ratio and form the desired temperature air-conditioned air. Note that in FIG. 1, the solid line position of the rear seat air mix door 18 shows the state with the second bypass passage 17 fully opened and the hot air H2 blocked. The two-dot chain position of the rear seat air mix door 18 shows the state with the second bypass passage 17 fully closed and the cold air C3 blocked.

As shown in FIG. 2, in this embodiment, the air passage in the air-conditioner case 1a is partitioned by a partition plate 19 positioned at the center of the vehicle width direction. The air passage at the driver's seat side (vehicle left side) in the air-conditioner case 1a and the air passage at the navigator's seat side (vehicle right side) are provided with independent cassette type film doors 14.

The film doors 14 independently provided at the driver's seat side and navigator's seat side may be independently operated so as to enable the temperature of the air-conditioned air blown into the driver's seat side passenger compartment and the temperature of the air-conditioned air blow into the navigator's seat side passenger compartment to be independently adjusted.

The film door 14 of the driver's seat side (vehicle left side) is arranged abutting against the front surface (surface at air flow upstream side) of the cold air side opening panel 11 and hot air side opening panel 12 formed at the rear side case member 1d.

Similarly, the film door 14 of the navigator's seat side (vehicle right side) is arranged abutting against the front surface of the cold air side opening panel 11 and hot air side opening panel 12 formed at the rear side case member 1d.

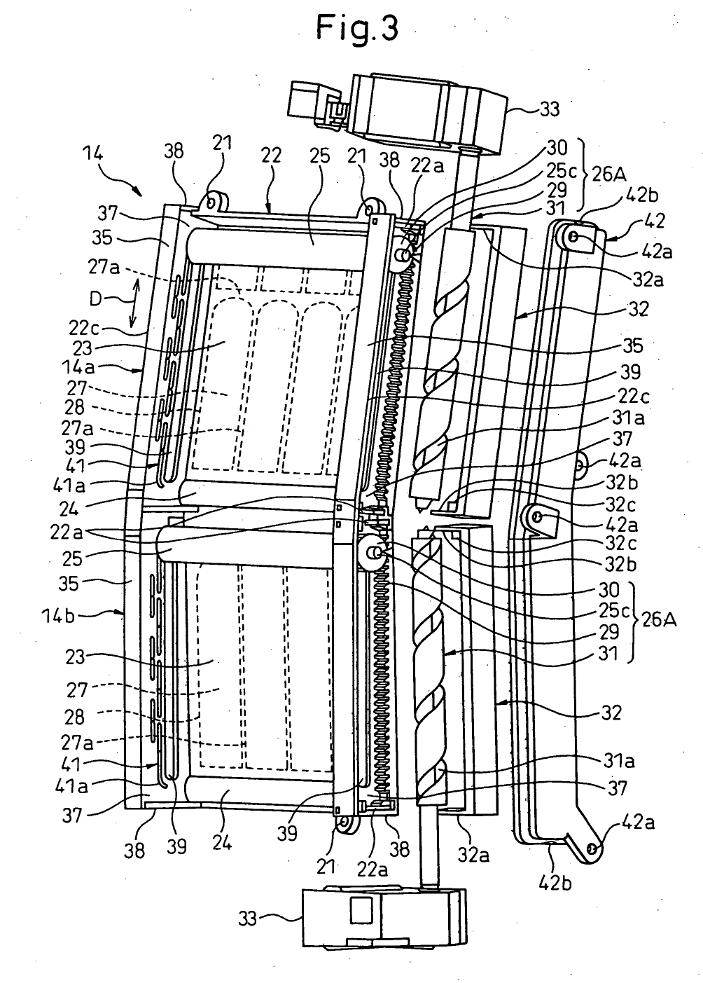

FIG. 3 is a perspective view showing the film door 14 of the driver's seat side alone. Note that the film door 14 at the navigator's seat side is configured symmetric with the film door 14 of the driver's seat side (vehicle left side) in the left-right direction, so illustration will be omitted. Below, the film door 14 of the driver's seat side will be explained.

The film door 14 is comprised of a cold air passage opening/closing unit 14a opening and closing the cold air side opening 11a of the cold air side opening panel 11 and a hot air passage opening/closing unit 14b opening and closing the hot air side opening 12a of the hot air side opening panel 12 formed integrally aligned in the vertical direction.

This integrally formed film door 14 is formed with three mounting holes 21 corresponding to three mounting bosses 20 provided at the rear side case member 1d. Not shown screws are inserted into the three mounting holes 21 and screwed into female screw holes of the mounting bosses 20 so as to fasten the film door 14 to the rear side case member 1d.

The cold air passage opening/closing unit 14a and the hot air passage opening/closing unit 14b of the film door 14 are configured substantially the same, so below the cold air passage opening/closing unit 14a will be explained. Parts the same or equivalent to the cold air passage opening/closing unit 14a in the hot air passage opening/closing unit 14b are assigned the same reference numerals and explanations are omitted.

The cold air passage opening/closing unit 14a is comprised of a substantially rectangular base member 22 integrally formed by a plastic above which a film-shaped member 23, fixed shaft 24, windup shaft 25, and windup shaft drive mechanisms 26A and 26B etc. are arranged.

The surface of the substantially rectangular base member 22 against which the cold air side opening panel 11 and hot air side opening panel 12 abut is formed bent at a slight angle matching with the inclinations of the cold air side opening panel 11 and hot air side opening panel 12.

This slightly bent surface is formed with an opening 27 overlapping the cold air side opening 11a of the cold air side opening panel 11. Due to this, the cold air cooled by passing through the evaporator 3 passes through the opening 27 and cold air side opening 11a and flows to the first bypass passage 13.

The film-shaped member 23 opens and closes the cold air side opening 11a by opening and closing this opening 27. As a specific material, various plastic materials having flexibility able to be wound up by the windup shaft 25 can be used.

For example, PET (polyethylene terephthalate) film, PPS (polyphenylene sulfide) film, etc. are suitable. These film materials may also be laminated on woven fabric. Further, the thickness of the film-shaped member 23 may be for example 200 μm or so.

The fixed shaft 24 is arranged at the bottom side of the opening 27 and fixes the bottom end side of the film-shaped member 23. That is, in the base member 22, the peripheral edges at the opening 27 are formed with a flat seal face 28. One end of the film-shaped member 23 is fixed to the seal face 28 by the fixed shaft 24. Note that the fixed shaft 24 corresponds to the fixing part in the present invention.

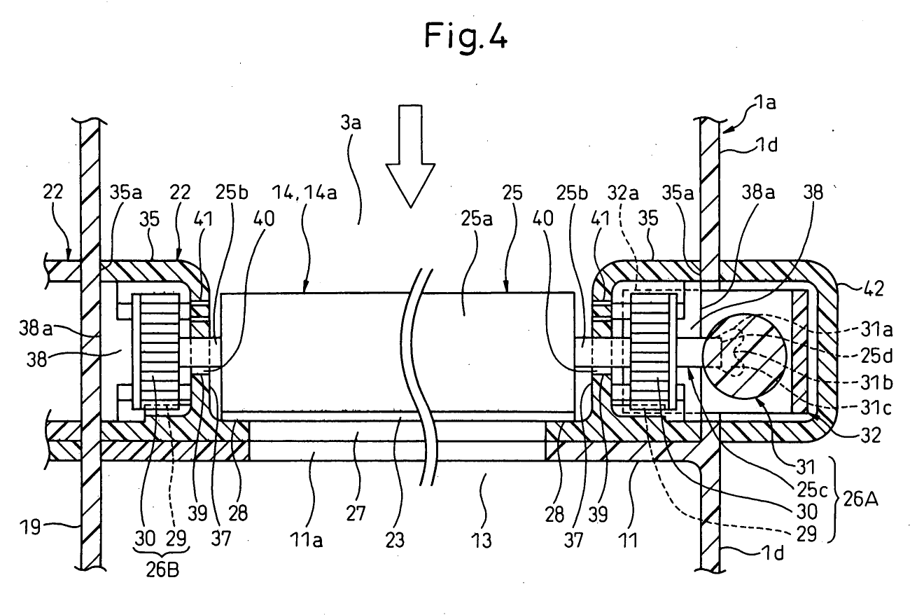

FIG. 4 shows an enlarged cross-sectional view of the part B-B in FIG. 2. As shown in FIG. 4, the windup shaft 25 is comprised of a windup part 25a for winding up the film-shaped member 23 and small diameter parts 25b at the two ends of the windup part 25a. The top end of the film-shaped member 23 is connected to the windup part 25a.

A windup shaft drive mechanism 26A provided at one end of the base member 22 in the left-right direction (right side of FIG. 4) is comprised of a rack 29, pinion 30, projection 25c of the windup shaft 25, and cylindrical drive shaft 31. The windup shaft drive mechanism 26B provided at the other side of the base member 22 in the left-right direction (left side of FIG. 4) is comprised of a rack 29 and pinion 30.

The racks 29 are formed integrally with the base member 22 of the film door 14 by a plastic and are arranged at the long parts of the left and right of the base member 22. Therefore, the racks 29 are arranged in directions perpendicular to the axial direction of the windup shaft 25.

The two ends of the windup shaft 25 are provided with pinions 30. The pinions 30 are designed to mesh with the rack 29.

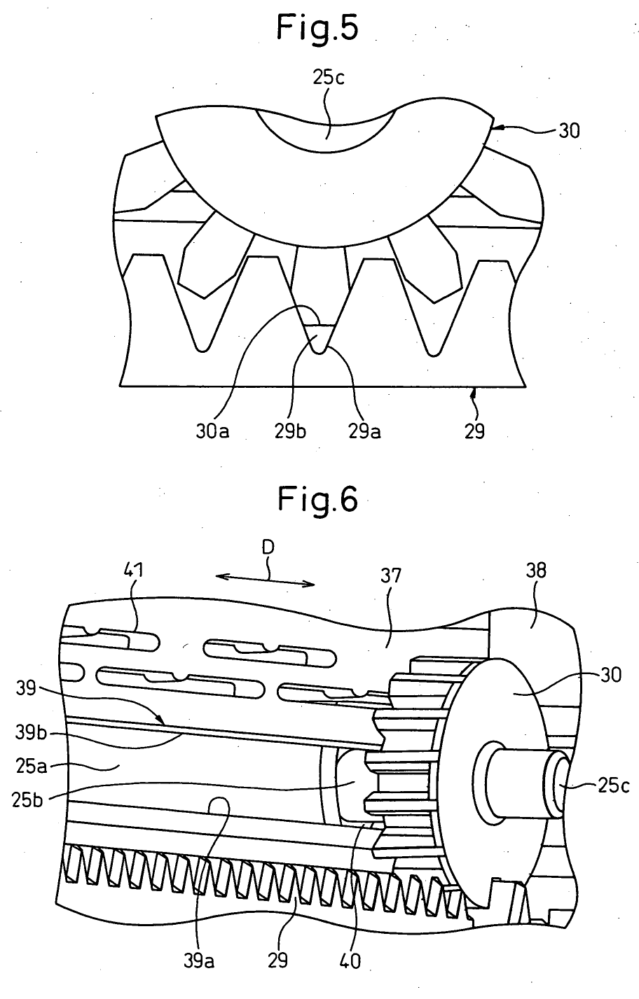

FIG. 5 is an enlarged view of a rack 29 and pinion 30 and shows the state of the pinion 30 meshed with the rack 29. In this embodiment, the rack 29 is formed by a plastic, so the gear roots 29a of the rack 29 can be formed deeply in cross-sectional V-shapes.

That is, when forming the rack 29 by cutting metal, since a blade is used to cut away the metal, there are limits to how narrowly and deeply the gear roots 29a of the rack 29 can be made, so forming the gear roots 29a into cross-sectional V-shapes is difficult. On the other hand, as in this embodiment, if forming the rack 29 from plastic, there is no limitation in shaping and the gear roots 29a can be easily formed into cross-sectional V-shapes.

Further, since the gear roots 29a of the rack 29 are formed in cross-sectional V-shapes, extraneous materials catches 29b can be formed between the gear roots 29a of the rack 29 and the gear tips 30a of the pinion 30.

Note that the pinion 30 and the windup shaft 25 have a not shown coil spring attached between them. The windup shaft 25 is tensed by this coil spring in a direction winding up the film-shaped member 23.

By extending the small diameter part 25b at the outer side of the rear case member 1d (right side in FIG. 4) among the small diameter parts 25b at the two ends of the windup shaft 25 toward the outer side of the rear side case member 1d, a projection 25c projecting out from the pinion 30 is formed.

At the projecting direction side of this projection 25c, a cylindrical drive shaft 31 is arranged facing the same direction as the rack 29. Therefore, the drive shaft 31 is arranged in a direction perpendicular to the axial direction of the windup shaft 25.

This cylindrical drive shaft 31 is formed at its outer circumference with a spiral groove 31a. This spiral groove 31a has the projection 25c of the windup shaft 25 mated with it.

The drive shaft 31 is rotatably supported through the bracket 32 with respect to the base member 22. The bracket 32 is formed into an approximately U-shape having facing surfaces 32a, 32b facing each other at its two ends.

One of the facing surfaces 32a of the bracket 32 is formed with a through hole (not shown). This through hole has one end of the drive shaft 31 (top end of film door 14) inserted into it in a rotatable manner. The other facing surface 32b is formed with a cylindrical mating part 32c. The front end of the other end of the drive shaft 31 (center of film door 14 in vertical direction) is rotatably mated with the cylindrical mated part 32c.

Further, the front ends 32d 32e of the two facing surfaces 32a and 32b of the substantially U-shaped bracket 32 mate with the mating grooves 22a of the base member 22 side to fasten the bracket 32 to the base member 22, whereby the drive shaft 31 is rotatably supported with respect to the base member 22.

At this time, as shown in FIG. 4, the drive shaft 31 and bracket 32 are arranged so as to project from the side wall of the rear side case member 1d to the outside (right side of FIG. 4).

The drive shaft 31 and bracket 32 projecting from the side wall of the rear side case member 1d to the outside are covered by a cover member 42. This cover member 42 has a box shape overall in the present embodiment and is formed from a plastic.

The cover member 42 is arranged to cover the drive shaft 31 and bracket 32 from the outer side of the case (right side in FIG. 4) and fastened to the case members 1b and 1d by screw means after fastening the film door 14 to the rear side case member 1d and fastening the case members 1b, 1c, and 1d together.

Specifically, not shown screws are inserted into the four mounting holes 42a formed at the cover member 42 and screwed into not shown female screw holes at the case member 1b and 1d side so that the cover member 42 is fastened to the case members 1b and 1d.

Due to this, the drive shaft 31 and bracket 32 are accommodated in the box-shaped cover member 42. Further, the cover member 42 is formed at its long direction (vertical direction of FIG. 3) end with a cutaway part 42b. One end of the drive shaft 31 is designed to project out from the cutaway part 42b to the outside of the cover member 42.

Further, the end of the drive shaft 31 projecting out to the outside of the cover member 42 is connected to the rotary shaft of the servo motor 33 at the outside of the case members 1b and 1d and driven to rotate.

When the rotational drive of the servo motor 33 causes the drive shaft 31 to rotate, the mating position of the spiral groove 31a and the projection 25c of the windup shaft 25 changes in the axial direction of the drive shaft 31, whereby a pushing force acts directly from the wall surface of the spiral groove 31a to the projection 25c of the windup shaft 25.

This pushing force causes the pinions 30 at the two ends of the windup shaft 25 to rotate on the racks 29 and move in the arrow D direction of FIG. 3 (direction perpendicular to the paper surface in FIG. 4), so the windup shaft 25 rotates and moves in a direction away from or approaching the fixed shaft 24 along a plane parallel to the seal face 28.

Along with this rotation and movement of the windup shaft 25, the film-shaped member 23 can be wound up or fed out from above and the opening area of the cold air side opening 11a of the air-conditioner case 1a side can be adjusted. As a result, the amount of cold air passing through the first bypass passage 13 can be adjusted.

Further, when the film-shaped member 23 fully closes the cold air side opening 11a of the air-conditioner case 1a side, the film-shaped member 23 is pushed by the pressure of the cold air against the seal face 28. Due to this, when the cold air side opening 11a is fully closed, sealability is exhibited between the film-shaped member 23 and the seal face 28 and cold air can be blocked out well.

The opening 27 of the base member 22 has a plurality of struts 27a arranged in it in a direction parallel or perpendicular to the movement direction D of the windup shaft 25. These struts 27a prevent the pressure of the cold air from causing the film-shaped member 23 to bend (swell) by a large amount to the air flow downstream side. Note that in this embodiment, this plurality of struts 27a are formed integrally with the base member 22.

As shown in FIG. 4, the bottom part 31b of the spiral groove 31a of the drive shaft 31 is formed so as to become deeper than the front end 25d of the projection 25c of the windup shaft 25. For this reason, a extraneous materials catch 31c is formed between the front end 25d of the projection 25c of the windup shaft 25 and the bottom part 31b of the spiral groove 31a of the drive shaft 31.

The film door 14 is provided with blocking walls 35 covering the parts of the windup shaft drive mechanisms 26A and 26B at the air flow upstream side and thereby preventing blown air from directly striking the windup shaft drive mechanisms 26A and 26B.

The blocking walls 35 correspond to the blown air blocking part in the present invention. Below, the blocking walls 35 will be explained.

The blocking walls 35 are arranged at the two ends of the base member 22 in the left-right direction. They have substantially rectangular flat shapes facing the racks 29 so as to cover the left and right racks 29 and pinions 30 of the base member 22 from the air flow upstream side and are formed integrally with first and second partition walls 37 and 38 and the base member 22 of the film door 14.

The first partition walls 37 are formed along the entire length of the base member 22 in the vertical direction extending from the seal faces 28 at the two sides of the opening 27 at the left and right to the left and right blocking walls 35. The first partition walls 37 are formed with long relief holes 29 with long directions facing the arrow D direction. Note that the first partition walls 37 correspond to the partition wall in the present invention.

FIG. 6 is a perspective view of the vicinity of a relief hole 39 of a first partition wall 37 and shows the state when viewed from the drive shaft 31 side to the first partition wall 37 side. As shown in FIG. 6, a small diameter part 25b at the end of the windup shaft 25 is inserted into the relief hole 39. When the windup shaft 25 rotates and moves, the small diameter part 25b moves in the relief hole 39 in the arrow D direction.

The second partition walls 38 are formed at the vertical direction ends of the base member 22 so as to extend from the left and right first partition walls 37 toward the rack 29 side.

As shown in FIG. 4, at the right side of the base member 22, the end face 35a of the blocking wall 35 and the end face 38a of the second partition wall 38 abut against the side wall of the front side case member 1b. Further, at the left side of the base member 22, the end face 35a of the blocking wall 35 and the end face 38a of the second partition wall 38 abut against the flat surface of the partition plate 19.

Therefore, the windup shaft drive mechanism 26A at the right side of the base member 22 is held in a space separated by the blocking wall 35 and first and second partition walls 37 and 38, etc. from the cold air passage 3a, while the windup shaft drive mechanism 26B at the left side of the base member 22 is held in the space separated by the blocking wall 35 and first and second partition walls 37 and 38, etc. from the cold air passage 3a.

As shown in FIG. 6, a gap 40 of a predetermined dimension is provided between the end face 39a of the relief hole 39 of the first partition wall 37 at the rack 29 side (bottom side of FIG. 6) and the outer circumference of the small diameter part 25b of the windup shaft 25.

On the other hand, the end face 39b of the relief hole 39 facing this end face 39a slides with the outer circumference of the small diameter part 25b of the windup shaft 25. Due to this, the windup shaft 25 is pushed from the end face 39b to the rack 29 side. For this reason, the pinion 30 is pushed against the rack 29, so the pinion 30 can be prevented from detaching from the rack 29 and spinning idlely.

Further, the part of the first partition wall 37 near the end face 39b of the relief hole 39 is formed with a large number of slits 41 substantially parallel to the end face 39b. As shown in FIG. 3, among this large number of slits 41, the slits at the two ends of the relief hole 39 in the long direction are formed with arcuate parts 41a running along the arcuate shape of the relief hole 39.

Next, the actions and effects of the embodiments will be explained. Note that below, the actions and effects of the cold air passage opening/closing unit 14a of the film door 14 will be explained. The hot air passage opening/closing unit 14b gives the same actions and effects as the cold air passage opening/closing unit 14a, so the explanation of the actions and effects will be omitted.

If the electric blower in the blowing unit is operated, the cold air cooled by passing through the evaporator 3 flows inside the cold air passage 3a toward the film door 14.

Further, the film-shaped member 23 of the film door 14 adjusts the opening area of the cold air side opening 11a at the air-conditioner case 1a side so as to adjust the flow rate of the cold air flowing through the first bypass passage 13.

At this time, as shown in FIG. 4, the cold air flowing toward the windup shaft drive mechanisms 26A and 26B is blocked by the blocking wall 35, so cold air can be prevented from directly striking the windup shaft drive mechanisms 26A and 26B.

As a result, extraneous materials (sand, dust, etc.) which contaminate the cold air can be prevented from depositing at the windup shaft drive mechanisms 26A and 26B and causing malfunctions or noise.

Specifically, extraneous materials can be prevented from being caught between the racks 29 and pinions 30 and being caught between the spiral groove 31a of the drive shaft 31 and the projection 25c of the windup shaft 25 and thereby causing malfunctions or the generation of noise.

Further, in this embodiment, the windup shaft drive mechanisms 26A and 26B are accommodated in the spaces at the left and right sides of the base member 22 separated by the blocking walls 35 and first and second partition walls 37 and 38, etc. from the cold air passage 3a.

For this reason, the cold air blocked by the blocking walls 35 can be prevented from invading the windup shaft drive mechanism 26A and 26B sides by sneaking around from directions other than the air flow upstream side. As a result, extraneous materials (sand, dust, etc.) which contaminate the blown air can be better prevented from depositing at the windup shaft drive mechanisms 26A and 26B and causing malfunctions or noise.

In this embodiment, the first partition walls 37 are formed with relief holes 39 for enabling the small diameter parts 25b at the two ends of the windup shaft 25 to move in the arrow D direction (front-back sides of paper surface in FIG. 4). Part of the cold air ends up passing through the relief holes 39 and flowing to the windup shaft drive mechanisms 26A and 26B.

For this reason, while small in amount, the extraneous materials which contaminate the cold air (sand, dust, etc.) sometimes deposit at the windup shaft drive mechanisms 26A and 26B.

Therefore, in this embodiment, extraneous materials catches 29b were formed between the gear tips 30a of the racks 29 and the gear roots 29a of the pinions 30, while a extraneous materials catch 31c was formed between the front end 25d of the projection 25c of the windup shaft 25 and bottom 31b of the spiral groove 31a of the drive shaft 31.

For this reason, even if extraneous materials deposit at the racks 29 or spiral groove 31a of the drive shaft 31, the extraneous materials are collected in the extraneous materials catches 29b and 31b.

As a result, extraneous materials can be prevented from being caught between the gear roots 29a of the racks 29 and the gear tips 30a of the pinions 30 or between the front end 25d of the projection 25c of the windup shaft 25 and the bottom 31b of the spiral groove 31a of the drive shaft 31.

Further, gaps 40 of predetermined dimensions are provided between the outer circumferences of the small diameter parts 25b of the windup shaft 25 and the end faces 39a of the relief holes 39 on the rack 29 side (bottom side of FIG. 6), so extraneous materials can be prevented from being caught between the outer circumference of the small diameter parts 25b of the windup shaft 25 and the end faces 39a of the relief holes 39 at the rack 29 side.

On the other hand, no gaps of predetermined dimensions are provided between the end faces 39b of the relief holes 39 facing the end faces 39a and the outer circumferences of the small diameter parts 25b of the windup shaft 25. The outer circumferences of the small diameter parts 25b are designed to slide with the end faces 39b.

Therefore, in this embodiment, the parts of the first partition walls 37 near the end faces 39b of the relief holes 39 are formed with large numbers of slits 41 substantially parallel to the end faces 39b. Due to this, when extraneous materials deposit between the outer circumferences of the small diameter parts 25b of the windup shaft 25 and the end faces 39b of the relief holes 39, the end faces 39b of the relief holes 39 can elastically deform to the slit 41 sides.

That is, by deforming the slits 41 to be crushed in the width direction (vertical direction of FIG. 6), the end faces 39b of the relief holes 39 can elastically deform so enable the release of caught extraneous materials.

For this reason, it is possible to avoid extraneous materials from being caught between the outer circumference of the small diameter parts 25b of the windup shaft 25 and the end faces 39b of the relief holes 39 and thereby obstructing rotation and movement of the windup shaft 25.

Further, among this large number of slits 41, the slits at the two ends of the relief holes 39 in the long direction are formed with arcuate parts 41a running along the arcuate shapes of the relief holes 39. For this reason, the two ends of the relief holes 39 in the long direction can also easily elastically deform so that the end faces of the relief holes 39 release the caught extraneous materials.

### Second Embodiment

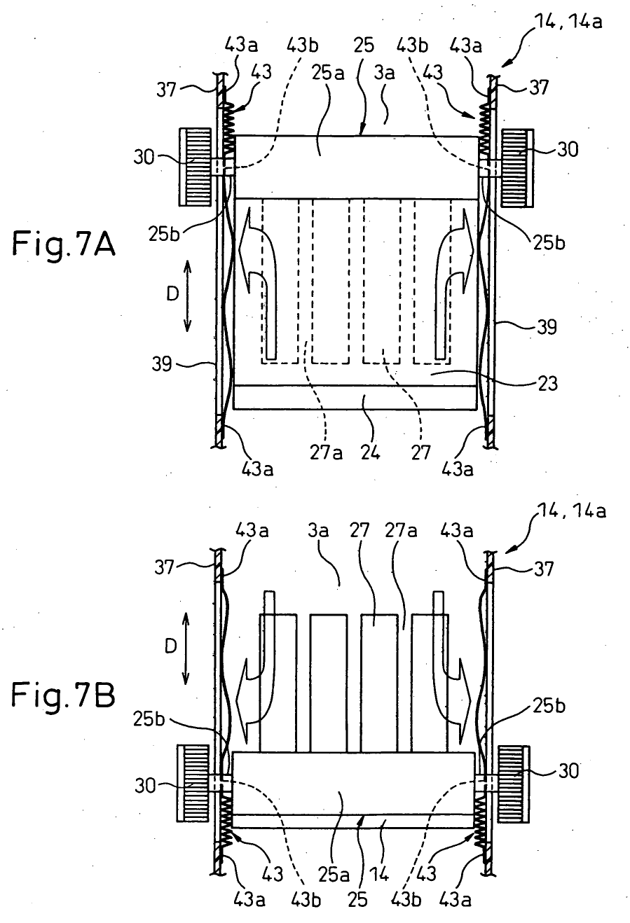

In the first embodiment, part of the cold air passes through the relief holes 39 of the first partition walls 37 and flows to the windup shaft drive mechanisms 26A and 26B, but in the second embodiment, as shown in FIGS. 7A and 7B, film-shaped blocking members 43 are arranged at the relief holes 39 to block cold air from passing through the relief holes 39, so extraneous materials can be better prevented from depositing at the windup shaft drive mechanisms 26A and 26B.

FIG. 7A is a schematic cross-sectional view of principal parts of the cold air passage opening/closing unit 14a of the film door 14 in the present embodiment, while FIG. 7B shows the state with the cold air side opening 11a fully opened in FIG. 7A.

Note that the hot air passage opening/closing unit 14b is substantially the same in configuration as the cold air passage opening/closing unit 14a, so the illustration and explanation are omitted.

As the film-shaped blocking members 43 in the present embodiment, in this embodiment, plastic film materials are used. The film-shaped blocking members 43 are arranged at the surfaces of the left and right first partition walls 37 at the cold air passage 3a side.

The film-shaped blocking members 43 are positioned across the entire lengths of the first partition walls 37 in the height directions of the first partition walls 37 (directions perpendicular to paper surface of FIG. 7). The two ends 43a of the windup shaft 25 in the movement direction D are fastened to the first partition walls 37 by adhesion etc.

The film-shaped blocking members 43 are formed, at the approximate centers of their movement directions D, with insertion holes 43b in which the small diameter parts 25b of the windup shaft 25 are slidably inserted. The lengths of the film-shaped blocking members 43 in the movement directions D are longer than the lengths of the relief holes 39 in the long directions by exactly predetermined dimensions.

As shown in FIG. 7A, in the state with the cold air passage opening/closing unit 14a fully closing the cold air side opening 11a, the parts of the film-shaped blocking members 43 above the insertion holes 43b (sides in direction away from fixed shaft 24) are folded up. On the other hand, the parts of the film-shaped blocking members 43 below the insertion holes 43b (sides in direction approaching fixed shaft 24) are extended.

For this reason, since the relief holes 39 of the first partition walls 37 are blocked by the film-shaped blocking members 43, the cold air can be kept from flowing from the cold air passage 3a through the relief holes 39 to the windup shaft drive mechanisms 26A and 26B.

As shown in FIG. 7B, when the windup shaft 25 rotates and moves in a direction approaching the fixed shaft 24 (bottom direction of FIG. 7) and fully opens the cold air side opening 11a, the inner circumferences of the insertion holes 43b of the film-shaped blocking members 43 are pushed downward (side in direction approaching fixed shaft 24) by the outer circumferences of the small diameter parts 25b of the windup shaft 25.

For this reason, the parts of the film-shaped blocking members 43 below the insertion holes 43b are folded up, while the parts of the film-shaped blocking members 43 above the insertion holes 43b (sides in direction moving away from fixed shaft 24) are extended.

That is, by making the lengths of the film-shaped blocking members 43 in the movement direction D longer than the lengths of the relief holes 39 in the long direction by exactly predetermined dimensions, even if first sides of the film-shaped blocking members 43 are folded up along with movement of the windup shaft 25, the film-shaped blocking members 43 will no longer become insufficient in length and the entire relief holes 39 can be blocked.

For this reason, the relief holes 39 of the first partition walls 37 are blocked by the film-shaped blocking members 43, so cold air can be kept from flowing from the cold air passage 3a through the relief holes 39 to the windup shaft drive mechanisms 26A and 26B.

In this way, in this embodiment, regardless of the opened/closed state of the cold air side opening 11a, the relief holes 39 of the first partition walls 37 are blocked by the film-shaped blocking members 43, therefore cold air can be kept from flowing from the cold air passage 3a through the relief holes 39 to the windup shaft drive mechanisms 26A and 26B.

As a result, extraneous materials which contaminate the cold air can be prevented more from depositing at the windup shaft drive mechanisms 26A and 26B.

### Third Embodiment

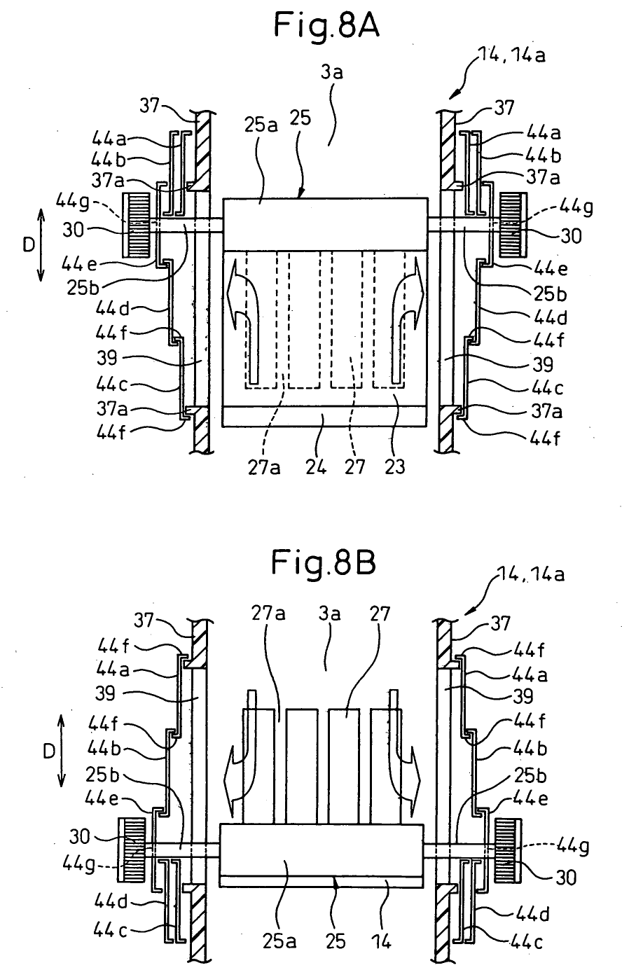

In the above second embodiment, film-shaped blocking members 43 are positioned at the relief holes 39 to block cold air from passing through the relief holes 39, but in the third embodiment, as shown in FIGS. 8A and 8B, multilayer slide doors 44 are positioned at the relief holes 39 to block the cold air from passing through the relief holes 39.

FIG. 8A is a schematic cross-sectional view of principal parts of the cold air passage opening/closing unit 14a of the film door 14 in the present embodiment and shows the state with the cold air side opening 11a fully closed, while FIG. 8B shows the state with the cold air side opening 11a fully opened in FIG. 8A.

Note that hot air passage opening/closing unit 14b is substantially the same in configuration as the cold air passage opening/closing unit 14a, so the illustration and explanation are omitted.

The multilayer slide doors 44 in the present embodiment use the basic structure of the multilayer slide doors in Japanese Patent Application No. 2004-265325 previously filed by the same assignee.

The multilayer slide doors 44 in the present embodiment are positioned at the left and right first partition walls 37 at the sides opposite to the cold air passage 3a. In this embodiment, the multilayer slide doors 44 are comprised of first to fifth thin plate members 44a to 44e formed from a plastic stacked in directions perpendicular to the first partition walls 37.

Specifically, first and second thin plate members 44a and 44b are stacked at first ends of the relief holes 39 in the long direction, third and fourth thin plate members 44d and 44d are stacked at seconds ends in the long direction, and fifth thin plate members 44e are stacked so as to straddle the second thin plate member 44b and fourth thin plate member 44d.

Projections 44f are formed at the two ends of the first to fifth thin plate members 44a to 44e in the front-back directions. The first to fifth thin plate members 44a to 44e engage with each other by the projections 44f. First projections 44f of the first and third thin plate members 44a and 44c adjoining the first partition walls 37 among the stacked first to fifth thin plate members 44a to 44e engage with projections 37a formed integrally with the first partition walls 37.

Note that in FIGS. 8A and 8B, for convenience in illustration, only some of the projections 44f formed at the two ends of the first to fifth thin plate members 44a to 44e in the front-back direction are assigned reference numerals. The reference numerals of the other projections 44f are omitted.

The fifth thin plate members 44e stacked straddling the second thin plate members 44b and fourth thin plate members 44d are formed at their centers with insertion holes 44g in which the small diameter parts 25b of the windup shaft 25 are slidably inserted.

Note that first to fifth thin plate members 44a to 44e are formed extending over the entire lengths of the first partition walls in the height directions of the first partition walls 37 (directions perpendicular to paper surface in FIG. 8). Therefore, the first to fifth thin plate members 44a to 44e slide against the blocking walls 35 and the flat parts of the base member 22 facing the blocking walls 35 at the two end faces of the first partition walls 37 in the height direction.

As shown in FIG. 8A, in the state with the cold air passage opening/closing unit 14a fully closing the cold air side opening 11a, first ends of the first and second thin plate members 44a and 44b abut against the small diameter parts 25b of the windup shaft 25, and first and second thin plate members 44a and 44b are stacked so as to overlap at first ends of the relief holes 39 in the long direction. Further, the third to fifth thin plate members 44c to 44e overlap with each other only at the ends and are stacked in states offset in staircase like manners.

At this time, the other projections 44f of the third thin plate members 44c are engaged with the projections 37a formed integrally with the first partition walls 37, so the multilayer slide doors 44 formed by the first to fifth thin plate members 44a to 44e overlap the relief holes 39.

For this reason, the relief holes 39 of the first partition walls 37 are blocked by the multilayer slide doors 44, so cold air can be kept from flowing from the cold air passage 3a through the relief holes 39 to the windup shaft drive mechanisms 26A and 26B.

As shown in FIG. 8B, when the windup shaft 25 rotates and moves in a direction approaching the fixed shaft 24 (bottom direction of FIG. 8) and the cold air side opening 11a is fully opened, the inner circumferences of the insertion holes 44g of the fifth thin plate members 44e are pushed by the outer circumferences of the small diameter parts 25b of the windup shaft 25 and the fifth thin plate members 44e move to the bottom side (side in direction approaching the fixed shaft 24).

Along with movement of the fifth thin plate-members 44e, the fifth thin plate members 44e and the second thin plate members 44b engage by the projections 44f and the second thin plate members 44b move in the same direction. If the second thin plate members 44b move, the second thin plate members 44b and the first thin plate members 44a engage by the projections 44f and the first thin plate members 44a move in the same direction. For this reason, the first and second thin plate members 44a and 44b are stacked in a state offset like a staircase.

On the other hand, first end faces of the third and fourth thin plate members 44c and 44d are moved while pushed against the outer circumferences of the small diameter parts 25b of the windup shaft 25. The third and fourth thin plate members 44c and 44d are stacked so that they overlap at the other ends of the relief holes 39 in the long direction.

At this time, first projections 44 of the first thin plate members 44a are engaged with the projections 37a formed integrally with the first partition walls 37, so the multilayer slide doors 44 formed by the first to fifth thin plate members 44a to 44e overlap the relief holes 39.

For this reason, the relief holes 39 of the first partition walls 37 are blocked by the multilayer slide doors 44, so the cold air can be kept from flowing from the cold air passage 3a through the relief holes 39 to the windup shaft drive mechanisms 26A and 26B.

In this way, in this embodiment, regardless of the opened/closed state of the cold air side opening 11a, the relief holes 39 of the first partition walls 37 are blocked by the multilayer slide doors 44 whereby the cold air can be kept from flowing from the cold air passage 3a through the relief holes 39 to the windup shaft drive mechanisms 26A and 26B.

As a result, the same effects as in said second embodiment can be obtained.

### Fourth Embodiment

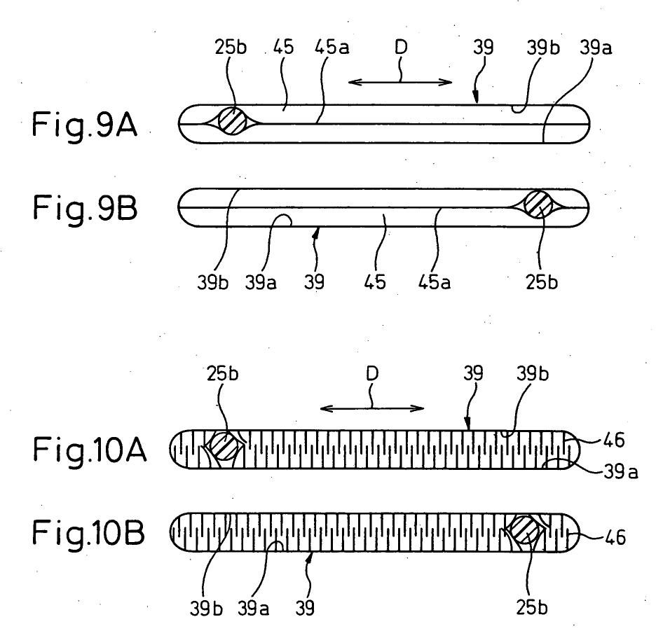

In the second embodiment, film-shaped blocking members 43 are positioned at the relief holes 39 and block the cold air passing through the relief holes 39. In the fourth embodiment, as shown in FIGS. 9A and 9B, elastic members 45 are arranged at the relief holes 39 and block the cold air from passing through the relief holes 39.

FIG. 9A is a schematic front view of one of the relief holes 39 of the first partition walls 37 of the cold air passage opening/closing unit 14a in the present embodiment and shows the state where the cold air side opening 11a is fully closed, while FIG. 9B shows the state where the cold air side opening 11a is fully opened in FIG. 9A.

Note that the relief holes 39 of the hot air passage opening/closing unit 14b side are configured the same as the cold air passage opening/closing unit 14a side, so the illustration and explanation are omitted.

The elastic members 45 in this embodiment are formed by an elastomer, rubber, or other elastic material and are arranged so as to block the relief holes 39. In this embodiment, the elastic members 45 are split into two by split surfaces 45a extending in the long direction of the relief holes 39 and are fastened by adhesion etc. to the inner circumferences of the relief holes 39.

As shown in FIG. 9A, in the state with the cold air side opening 11a fully closed, the split surfaces 45a of the elastic members 45 are pushed by the outer circumferences of the small diameter parts 25b of the windup shaft 25 to be elastistically deformed, whereby the small diameter parts 25b are inserted between the split surfaces 45a of the elastic members 45.

For this reason, the relief holes 39 of the first partition walls 37 are blocked by the elastic members 45, so cold air can be kept from flowing from the cold air passage 3a through the relief holes 39 to the windup shaft drive mechanisms 26A and 26B.

As shown in FIG. 9B, when the windup shaft 25 rotates and moves in a direction approaching the fixed shaft 24 (right direction of FIG. 9) and the cold air side opening 11a is fully opened, the windup shaft 25 pushes against the split surfaces 45a of the elastic members 45 by the outer circumferences of the small diameter parts 25b to elastically deform the elastic members 45 and move between the split surfaces 45a to the right side of FIG. 9.

For this reason, the relief holes 39 of the first partition walls 37 are blocked by the elastic members 45, so cold air can be kept from flowing from the cold air passage 3a through the relief holes 39 to the windup shaft drive mechanisms 26A and 26B.

In this way, in this embodiment, regardless of the opened/closed state of the cold air side opening 11a, the relief holes 39 of the first partition walls 37 are blocked by the elastic members 45, so cold air can be kept from flowing from the cold air passage 3a through the relief holes 39 to the windup shaft drive mechanisms 26A and 26B.

As a result, the same effects as in the second embodiment can be obtained.

### Fifth Embodiment

In the fourth embodiment, elastic members 45 are arranged at the relief holes 39 and block the cold air from passing through the relief holes 39, but in the fifth embodiment, as shown in FIGS. 10A and 10B, brush-shaped members 46 are arranged at the relief holes 39 and block the cold air from passing through the relief holes 39.

FIG. 10A is a schematic front view of one of the relief holes 39 of the first partition walls 37 of the cold air passage opening/closing unit 14a in the present embodiment and shows the state with the cold air side opening 11a fully closed, while FIG. 10B shows the state of the cold air side opening 11a fully opened in FIG. 10A.

Note that the relief holes 39 of the hot air passage opening/closing unit 14b side are configured the same as the cold air passage opening/closing unit 14a side, so the illustration and explanation are omitted.

The brush-shaped members 46 in this embodiment are comprised of elastically deformable plastic fiber-shaped members. Specifically, large numbers of fiber-shaped members are arranged so as to project out from the inner circumferences of the relief holes 39 to the inside diameter direction and are fastened to the inner circumferences of the relief holes 39 by adhesion etc.

As shown in FIG. 10A, in the state with the cold air side opening 11a fully closed, the brush-shaped members 46 (fiber-shaped members) near the small diameter parts 25b of the windup shaft 25 are pushed by the outer circumferences of the small diameter parts 25b to elastically deform, whereby the small diameter parts 25b are inserted into the brush-shaped members 46.

For this reason, the relief holes 39 of the first partition walls 37 are blocked by the brush-shaped members 46, so cold air can be kept from flowing from the cold air passage 3a through the relief holes 39 to the windup shaft drive mechanisms 26A and 26B.

As shown in FIG. 10B, when the windup shaft 25 moves in a direction approaching the fixed shaft 24 (right direction of FIG. 9) and fully opens the cold air side opening 11a, the windup shaft 25 moves to the right side of FIG. 9 while the outer circumferences of the small diameter parts 25b push against the brush-shaped members 46 (fiber-shaped members) to elastically deform them.

For this reason, the relief holes 39 of the first partition walls 37 are blocked by the brush-shaped members 46, so cold air can be kept from flowing from the cold air passage 3a through the relief holes 39 to the windup shaft drive mechanisms 26A and 26B.

In this way, in this embodiment, regardless of the opened or closed state of the cold air side opening 11a, the relief holes 39 of the first partition walls 37 are blocked by the brush-shaped members 46 and cold air can be kept from flowing from the cold air passage 3a through the relief holes 39 to the windup shaft drive mechanisms 26A and 26B.

As a result, the same effects as in the fourth embodiment can be obtained.

### Other Embodiments

Note that in the above embodiments, the bottom end of the cold air side opening panel 11 and the top end of the hot air side opening panel 12 are joined at a slight angle. Along with this, the base member 22 of the cassette type film door 14 is also formed slightly bent, but it is also possible to join the cold air side opening panel 11 and the hot air side opening panel 12 in a straight state. Along with this, the base member 22 of the cassette type film door 14 is also formed straight.

Further, in the above embodiments, the racks 29, blocking walls 35, first partition walls 37, etc. are formed integrally with the base member 22 and the film-shaped members 23, windup shafts 25, pinions 30, drive shafts 31, etc. are attached to the base member 22, and the thus assembled cassette type film door 14 is attached to the cold air side opening panel 11 and hot air side opening panel 12 at the air-conditioner case 1a sides, but it is also possible not to use the base member 22 and directly assemble separately formed racks 29, blocking walls 35, first partition walls 37, etc. and film-shaped members 23, windup shafts 25, pinions 30, drive shafts 31, etc. at the cold air side opening panel 11 and hot air side opening panel 12 of the air-conditioner case 1a side.

Further, in the above embodiments, the drive shaft 31 of the cold air passage opening/closing unit 14a and the drive shaft 31 of the hot air passage opening/closing unit 14b are designed to be connected to the rotary shafts of the servo motors 33 and driven to rotate, but it is also possible to link the drive shaft 31 of the cold air passage opening/closing unit 14a and the drive shaft 31 of the hot air passage opening/closing unit 14b by a gear or other linkage mechanism and connect this linkage mechanism to the rotary shaft of one servo motor 33 so as to drive the rotation of the drive shaft 31 of the cold air passage opening/closing unit 14a and the drive shaft 31 of the hot air passage opening/closing unit 14b by a single servo motor 33.

Further, in the above embodiments, in the windup shaft drive mechanism 26A, the drive shaft 31 is arranged to project from the side wall of the rear side case member 1d to the outside (right side of FIG. 4), but the drive shaft 31 may also be arranged at the inside from the side wall of the rear side case member 1d and the windup shaft drive mechanism 26A stored as a whole in the air-conditioner case 1a.

In this case, if arranging not only the rack 29 and pinion 30, but also the blocking wall 35 so as to cover the drive shaft 31 from the air flow upstream side, in the same way as the above embodiments, the windup shaft drive mechanism 26A can be prevented from being directly struck by the blown air.

Further, in the second embodiment, the film-shaped blocking members 43 are arranged at the left and right first partition walls 37 at the cold air passage 3a sides, but the film-shaped blocking members 43 may also be arranged at the left and right first partition walls 37 at the sides opposite to the cold air passage 3a.

Further, in the second embodiment, the film-shaped blocking members 43 are arranged across the entire lengths of the first partition walls 37 in the height directions of the first partition walls 37 (direction perpendicular to paper surface in FIG. 7), but the film-shaped blocking members 43 may also be arranged to overlap only the relief holes 39 in the height directions of the first partition walls 37.

Further, in the third embodiment, the multilayer slide doors 44 are arranged at the left and right first partition walls 37 at the sides opposite to the cold air passage 3a, but the multilayer slide doors 44 may also be arranged at the left and right first partition walls 37 at the cold air passage 3a sides.

Further, in the third embodiment, multilayer slide doors 44 are formed across the entire lengths of the first partition walls 37 in the height directions of the first partition walls 37 (direction perpendicular to the paper surface in FIG. 8), but they may also be arranged to overlap only the relief holes 39 in the height directions of the first partition walls 37.

Further, in the fifth embodiment, the brush-shaped members 46 are comprised of a large number of elastically deformable fiber-shaped members, but the brush-shaped members 46 may also be comprised of a large number of elastically deformable strip members.

While the invention has been described by reference to specific embodiments chosen for the purposes of illustration, it should be apparent that numerous modifications could be made thereto by those skilled in the art without departing from the basic concept and scope of the invention.

1. An air passage opening/closing system provided with:
a case forming an air passage through which blown air flows,
a film-shaped member arranged in said case and opening and closing an opening of said air passage,
a fixing part fixing one end of the film-shaped member at a peripheral edge of the opening,
a windup shaft connected to the other end of the film-shaped member and winding up and feeding out the film-shaped member, and
a windup shaft drive mechanism rotating said windup shaft and making it move over the opening in a direction away from and approaching the fixing part,
the windup shaft and windup shaft drive mechanism being arranged at an air flow upstream side of the opening,
a blown air blocking part covering at least an air flow upstream side part of the windup shaft drive mechanism being provided.

2. An air passage opening/closing system as set forth in claim 1, wherein
the windup shaft drive mechanism is provided at an end of the windup shaft,
a partition wall extending from the peripheral edge of the opening to the blown air blocking part is formed between the windup shaft drive mechanism and film-shaped member, and
a relief hole in which the windup shaft is inserted is formed in the partition wall in an elongated shape extending across a range of movement of the windup shaft.

3. An air passage opening/closing system as set forth in claim 2, wherein the partition wall is formed integrally with the blown air blocking part by plastic.

4. An air passage opening/closing system as set forth in claim 2, wherein the windup shaft drive mechanism is formed by a pinion provided at an end of the windup shaft and a rack meshing with the pinion.

5. An air passage opening/closing system as set forth in claim 4, wherein slits extending substantially in parallel with the end face are formed at a part of the partition wall near the end face.

6. An air passage opening/closing system as set forth in claim 2, wherein
the windup shaft drive mechanism is formed by a pinion provided at an end of the windup shaft and a rack meshing with the pinion and
the relief hole is formed so that a gap of a predetermined dimension is set between the outer circumference of the windup shaft at the side close to the rack and the end face of the relief hole.

7. An air passage opening/closing system as set forth in claim 4, wherein
the rack is formed by a plastic and
gear roots of the rack are formed in cross-sectional V-shapes, whereby extraneous materials catches are formed between the gear roots and the gear tips of the pinion.

8. An air passage opening/closing system as set forth in claim 7, wherein the rack is integrally formed with the partition wall and blown air blocker.

9. An air passage opening/closing system as set forth in claim 4, wherein the rack is integrally formed with the partition wall and blown air blocking part.

10. An air passage opening/closing system as set forth in claim 2, wherein movement of the windup shaft is allowed at the partition wall and a blocking member is provided blocking the relief hole.

11. An air passage opening/closing system as set forth in claim 10, wherein
the blocking member is formed by a film-shaped blocking member arranged so as to overlap the relief hole at the partition wall,
a length of the film-shaped blocking member in the movement direction is longer than the length of the relief hole in the movement direction by exactly a predetermined dimension, and
one side of the film-shaped blocking member in the movement direction is folded up and the other side is extended along with movement of the windup shaft.

12. An air passage opening/closing system as set forth in claim 10, wherein
the blocking member is formed by a multilayer slide door arranged so as to overlap the relief hole at the partition wall,
the multilayer slide door is comprised of a plurality of thin plate members stacked in the axial direction of the windup shaft, and
thin plate members at one side of the plurality of thin plate member in the movement direction are stacked so as to be overlaid and thin plate members at the other side are stacked so as to be offset in a staircase manner along with movement of the windup shaft.

13. An air passage opening/closing system as set forth in claim 10, wherein
the blocking member is formed by an elastic member arranged so as to overlap the relief hole at the partition wall,
the elastic member is formed with split surfaces extending substantially parallel to the movement direction of the windup shaft, and
the windup shaft pushes against the split surfaces and elastically deforms the elastic member to move between the split surfaces.

14. An air passage opening/closing system as set forth in claim 10, wherein the blocking member is formed by a large number of elastically deformable fiber- or strip-like brush members projecting from the inner circumference of the relief hole to the inside.
